(19) United States
(12) Patent Application Publication
(10) Pub. No.: US 2014/0061981 A1
(43) Pub. Date: Mar. 6, 2014

(54) CERAMIC FILTER AND METHODS FOR MANUFACTURING AND USING SAME

(71) Applicant: KUBOTA CORPORATION, Osaka (JP)

(72) Inventors: Hiroshi YAMAGUCHI, Takatsuki City (JP); Hiroaki OKANO, Ibaraki City (JP); Atsushi SUGAI, Ibaraki City (JP)

(73) Assignee: KUBOTA CORPORATION, Osaka (JP)

(21) Appl. No.: 14/017,197

(22) Filed: Sep. 3, 2013

Related U.S. Application Data
(60) Provisional application No. 61/696,561, filed on Sep. 4, 2012.

(51) Int. Cl. B01J 20/30; B01J 27/24

(52) U.S. Cl. CPC B01J 20/3078; B01J 27/24
USPC 264/610; 502/439; 423/344

(57) ABSTRACT

A process for manufacturing a ceramic filter includes mixing silicon, yttrium oxide-doped zirconia, magnesium-aluminum spinel, silicon nitride, a pore-forming material, and a binder to form a ceramic precursor; extruding the ceramic precursor into a generally honeycomb shaped monolithic filter precursor or into a single filter tube precursor; drying the filter precursor or filter tube precursor to form a dried ceramic precursor; heating the dried ceramic precursor to remove the binder; and sintering to form the silicon nitride ceramic filter.

### CROSS-REFERENCE TO RELATED APPLICATIONS

This application claims the benefit of priority to U.S. Provisional Patent Application No. 61/696,561, filed on Sep. 4, 2012, which is incorporated herein by reference in its entirety for any and all purposes.

### TECHNICAL FIELD

The present disclosure relates generally to ceramic filters and methods for manufacturing and using the same.

### BACKGROUND

Ceramic filters, such as diesel particulate filters, may be used to collect or filter out particulate matter having a wide particle size distribution. For example, such filters have been used to collect soot that is exhausted from a diesel engine. Typically, such ceramic filters have a substantially honeycomb configuration, which includes a substantially columnar body of porous ceramic that has a plurality of holes extending in parallel with one another in a length direction of the columnar body. The columnar body typically will have a wall portion interposed between the through holes. These wall portions can serve to filter particulate matter as the exhaust is flowed through the ceramic filter.

The columnar body of the ceramic filter may be formed using, for example, a monolithic approach or a segmented approach. In the monolithic approach, a one-piece honeycomb body forms the columnar body. In the segmented approach, the columnar body may be formed by providing a plurality of smaller, elongated honeycomb segments and then applying a ceramic seal layer between adjacent segments to adhere the segments to one another.

Cordierite and silicon carbide are ceramic materials commonly used in the construction of ceramic filters. However, cordierite and silicon carbide may be disadvantageous. For example, cordierite has a low particulate matter loading capacity due to its low thermal shock resistance from low mechanical strength. Silicon carbide has higher back-pressure that increases due to a larger grain size. In addition, with silicon carbide filters, particulate matter leakage may also be high at an initial stage or regeneration stage, because the trapping performance is low before a cake-like layer is generated due to particulate matter accumulation. Silicon carbide may also not be as good of a catalyst due to its lower specific surface area. Finally, the amount of wash-coating for a silicon carbide filter for catalyzing may also be limited. For example, in some embodiments, 20 g/L is a high amount for the specific surface area.

Regarding the type of material to be used in a monolithic or segmented ceramic filter, cordierite is possible for a monolithic ceramic filter due to the material having lower thermal stress during operation. However, cordierite may not be as appropriate for segmented ceramic filters, due to its lower mechanical strength in the joining segments. On the other hand, silicon carbide is a better material to use for segmented ceramic filters due to its high mechanical strength. However, silicon carbide may not be as appropriate for monolithic ceramic filters due to its higher thermal stress during operation.

### SUMMARY

In one aspect, a process for manufacturing a ceramic filter includes mixing silicon, yttrium oxide-doped zirconia, magnesium-aluminum spinel, silicon nitride, a pore-forming material, and a binder to form a ceramic precursor; extruding the ceramic precursor into a generally honeycomb shaped monolithic filter precursor or into a single filter tube precursor; drying the filter precursor or filter tube precursor to form a dried ceramic precursor; heating the dried ceramic precursor to remove the binder; and sintering to form the silicon nitride ceramic filter. In some embodiments, the heating the dried ceramic precursor to remove the binder is conducted at a temperature of from about 200° C. to about 500° C. In any of the above embodiments, the silicon nitride ceramic filter includes β-Si₃N₄, ZrO₂(Y₂O₃), MgO, and Al₂O₃. In any of the above embodiments, the sintering includes nitriding the silicon at a temperature of about 1300° C. to about 1500° C. in the presence of nitrogen, followed by heating at a temperature of about 1600° C. to about 1800° C. In any of the above embodiments, the ceramic precursor includes silicon from about 20 wt % to about 25 wt %, yttrium oxide-doped zirconia from about 0.1 wt % to about 3 wt %, magnesium-aluminum spinel from about 1 wt % to about 6 wt %, β-Si₃N₄ from about 15 wt % to about 25 wt %, pore-forming material from about 10 wt % to about 20 wt %, and organic binder from about 35 wt % to about 45 wt %. In any of the above embodiments, the silicon nitride ceramic filter includes β-Si₃N₄ at greater than or equal to about 93 wt %, yttrium oxide-doped zirconia at less than about 1.5 wt %, and MgO and Al₂O₃ at less than about 5.5 wt %.

In any of the above embodiments, the process may also include wash-coating the silicon nitride ceramic filter body with a wash-coating that includes aluminum oxide or titanium oxide. In any of the above embodiments, the wash-coating provides a coating of 20 g/L wash-coating or greater. In any of the above embodiments, the wash-coating provides a coating of 40 g/L wash-coating or greater. In any of the above embodiments, the wash-coating provides a coating of 60 g/L wash-coating or greater.

In another aspect, a ceramic filter includes a monolithic or composite body comprising β-Si₃N₄ and about 20 g/L or more of a catalyst support coating on the surface of the β-Si₃N₄.

In another aspect, a porous ceramic body includes a plurality of pores, wherein at least 10% of the plurality of pores have an average diameter of 10 μm or less. In some embodiments, the porous ceramic body is constructed from silicon nitride. In some such embodiments, the silicon nitride is β-Si₃N₄.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims.

FIGS. 1A and 1B show embodiments of a monolithic ceramic filter (1A) and a segmented ceramic filter (1B), respectively, in accordance with aspects of the present disclosure.

FIGS. 2A-2D show electron micrographs of the crystalline structure of an embodiment of the silicon nitride ceramic filter, and FIG. 2E is an illustration of silicon nitride crystal dimensions, according to one embodiment.

FIG. 3 illustrates a silicon carbide crystalline structure that is employed in ceramic filters, in accordance with aspects of the present disclosure.

FIG. 4 shows a chart illustrating the pore distribution for silicon nitride, silicon carbide, and cordierite.

FIG. 5 illustrates a graph and accompanying electron micrographs that provide more detailed insight regarding the pore distribution that may be achieved through use of silicon nitride, in accordance with aspects of the present disclosure.

FIG. 6 is a graph comparing the particulate matter leakage of silicon nitride and silicon carbide ceramic filters at initial values and during regeneration.

FIG. 7 is an illustration of the collection of particulate matter by silicon nitride crystals and silicon carbide crystals.

FIG. 8 includes graphs for both silicon nitride and silicon carbide illustrating the relatively low particulate matter leakage of silicon nitride ceramic filters, in accordance with aspects of the present disclosure.

FIG. 9 shows the typical porosity of silicon nitride and silicon carbide having the same level of the initial back-pressure.

FIG. 10 is a graph comparing the particulate matter loading amount for silicon nitride and silicon carbide.

FIG. 11 is a graph comparing the specific surface areas of grains of silicon nitride, silicon carbide, and cordierite.

FIG. 12 is a graph comparing the pressure increasing rate (%) as a function of wash-coat loading amount (g/L) for both silicon carbide (dotted line) and silicon nitride (solid line).

FIG. 13 is a cartoon illustration of the wash-coating of silicon nitride in comparison to silicon carbide.

FIG. 14 is a graph of the specific surface area v. wash-coating amounts for silicon nitride and silicon carbide.

FIGS. 15A, B, and C are electron micrographs of silicon nitride after wash-coating.

FIG. 16 illustrates tunneling electron microscopy (TEM) images of the wash-coat having a thickness of 10 to 30 nm.

FIG. 17 is a graph illustrating the relationship between hydrocarbon (HC) half-reduction temperature (T50) and the wash-coat amount of silicon nitride.

FIG. 18 is a graph illustrating how a larger amount of wash-coat retains a higher catalyst dispersion.

FIG. 19 is a series of 3 graphs illustrating the pressure increases for different wash-coating values (20 g/L, 40 g/L, and 60 g/L) for both silicon nitride and silicon carbide.

FIG. 20 is a graph of the regeneration efficiency (%) for silicon nitride and silicon carbide.

FIG. 21 includes a table compiling thermal gradient, thermal response and mechanical properties of the silicon nitride, silicon carbide, and cordierite.

FIG. 22 shows an actual illustration of what the ceramic filter looks like after regeneration of 20 minutes by post injection.

FIG. 23 includes a graph illustrating strength of silicon nitride.

FIG. 24 is a graph illustrating the weight (in grams) of accumulated material of both silicon carbide and silicon nitride as a function of time (in hours), according to the testing from Table 3.

FIG. 25 shows an example segmented composite ceramic filter body, in accordance with one aspect.

FIG. 26 is a flow diagram generally outlining a process to manufacture the segmented ceramic filter, in accordance with an aspect of the present disclosure.

FIG. 27 is a chart illustrating the conditions of the post-sintering process.

FIG. 28 includes a table that describes addition details regarding step 1 (nitriding) and step 2 (sintering) of the post-reaction sintering process.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

A ceramic filter formed from silicon nitride is provided. Such filters exhibit high mechanical strength and shock resistance. Porous silicon nitride may be structured with controlled small grain crystals of elongated hexagonal systems. This enables high particulate matter filtration efficiency with low back pressure increases, thereby providing for higher filtering efficiencies for small particulate matter. In addition, due to the controlled micro-structure of the silicon nitride, a larger amount of wash-coating of catalysts to the surfaces of the filter may be applied at lower back pressure increases than in conventional ceramics. A higher capacity of wash-coating of a catalyst support provides the potential for superior catalyst efficiency at lower concentrations of precious metals being used as the active catalyst components. With regard to manufacturing cost, silicon nitride provides another advantage, as a monolithic filter may be readily manufactured. According to another aspect, a method of preparing the filter includes a post-reaction sintering process is that enables the use of metal Si that is lower in cost than Si₃N₄ powder for raw material. Other advantages may be achieved, as described herein.

In one aspect, a ceramic filter is provided having a one-body (i.e. monolithic) structure. The monolithic structure may include a plurality of through-holes running in parallel from a proximal end of the monolithic structure to a distal end of the monolithic structure. A portion of the through-holes may be obstructed, or “plugged,” at one or both of the proximal or the distal end. The monolithic structure may be of a convenient, cross-sectional shape. For example, cross-sectional shapes may include, but are not limited to, cylindrical, hexagonal, or octagonal shapes. In any of the above embodiments, the ceramic filter may be constructed of silicon nitride (SiN; Si₃N₄). In some embodiments, the monolithic structure of a ceramic filter appears in a near-net shape. An outer surface of the ceramic filter may be machined to control the diameter of the filter. Throughout the ceramic filters, the silicon nitride has a high surface area that may, optionally, include a coating.

As used herein, “near net shape” refers to a shape having minimum machining thickness. For example, while the monolithic embodiments are produced in the shape of the final product, while the segmented filter embodiments prior to machining are a rectangular parallelepiped. Thus, the monolithic is near-net shape, while the segmented filters are not.

In another aspect, a ceramic filter is provided having a plurality of segmented filters that are secured together by an adhesive to form a composite filter body. Each of the segmented filters may include a plurality of through-holes running in parallel from a proximal end of the segmented filter to a distal end of the segmented filter. A portion of the through-holes may be obstructed (i.e. “plugged”) at one or both of the proximal end or the distal end. For example, one end may be obstructed, while the other remains unobstructed. The segmented filters may be of a convenient shape to be accumulated in the composite filter body. For example, the shape of each individual segmented filter may be cylindrical, hexagonal, or octagonal shape. The individual segmented filters may tit together to provide the ceramic filter having an overall cylindrical, hexagonal, or octagonal shape. The adhesive joining the individual segmented filters together may be a mixture of cordierite and aluminum oxide, or other adhesive. In any of the above embodiments, the surfaces (including all interior surfaces, i.e. the surface area) of the ceramic filter may be coated. In one embodiment, the surfaces of the ceramic filter may be coated with a mixture of silicon oxide and silicon nitride. The segmented filters may be constructed of silicon nitride.

In one aspect, a ceramic filter is provided. The filter may be a monolithic or composite body of β-Si₃N₄. The filter may also include a catalyst support coating on the β-Si₃N₄. The support coating may be present at about 20 g/L. In other words, about 20 g of the catalyst support coating is added for every about 1 L of ceramic material. In some embodiments, the catalyst support coating on the surface of the β-Si₃N₄ is present at about 40 g/L or more. In other embodiments, the catalyst support coating on the surface of the β-Si₃N₄ is present at about 60 g/L or more. The catalyst support coating may include materials such as aluminum oxide and titanium oxide.

In another aspect, a porous ceramic body is provided. The body includes a plurality of pores, where at least 10% of the pores have an average diameter of 10 μm or less. In some embodiments, the ceramic body is constructed of silicon nitride. In other embodiments, the silicon nitride is β-Si₃N₄. These and other embodiments and/or aspects will be further described by reference to the figures included herewith.

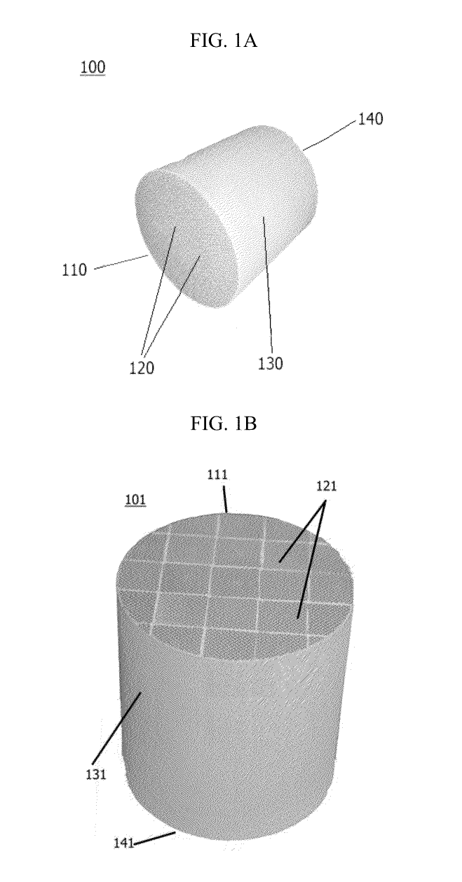

FIGS. 1A and 1B show embodiments of ceramic filters 100 in accordance with an aspect of the present disclosure. FIG. 1A is a photograph of a monolithic ceramic filter 100. FIG. 1B is a photograph a segmented ceramic filter 101. Each of the monolithic and segmented ceramic filters includes a proximal end 110,111, through-holes 120,121, an outer surface 130,131, and a distal end 140,141. As may be seen in FIGS. 1A and 1B, a plurality of parallel through-holes 120,121 extend from a proximal end 110,111 to a distal end 140,141.

In one embodiment, a portion of the through-holes 120,121 may be obstructed at either the proximal end 110,111 or at the distal end 140,141. In some such embodiments both ends may be open, one end or the other end is obstructed, or both ends may be obstructed. Alternatively, the proximal end 110,111, or the distal end 140,141 may be substantially obstructed or substantially open. As used herein, obstructed is intended to mean that the through-hole is plugged to free passage, although due to micro-structure of the ceramic it may be gas or liquid permeable. As used herein, “substantially” means that the through-hole is less than 100% obstructed due to imperfections, but it was intended to be obstructed.

As will be observed from FIGS. 1A and 1B, the ceramic body has an overall columnar shape. This overall shape may be formed as a monolith of the ceramic material, or it may be formed as a composite structure using a plurality of segmented filters that are secured together by an adhesive to form a composite filter body. The monolithic approach may be more efficient and cost-effective to produce due to the requirement for lesser material costs and fewer processing steps, as opposed to using individual filter components to produce the composite.

In the case of either the monolithic or composite ceramic filter bodies, the ceramic may be silicon nitride. Silicon nitride has a mechanical strength that is superior to cordierite by approximately 200%, as measured by a compression strength method. The monolithic ceramic files of silicon nitride also has a lower cost of manufacture than those of silicon carbide (SiC). However, the composite filters have the advantage of lower mechanical stress in the diameter axis (i.e. latitudinal direction) because the bonding materials(adhesives) act as a stress absorber.

Generally, silicon nitride is a thermally resistant ceramic, exhibiting high mechanical strength. Furthermore, porous silicon nitride may be structured with controlled small grain crystals having an elongated hexagonal shape. This enables high particulate matter filtration efficiency with low back pressure, as well as increased and higher filtering efficiencies for smaller particulate matter. Also, due to the micro-structure of silicon nitride, a larger amount of wash-coating may be applied with lower back pressure when compared to conventional materials. A higher capacity of wash-coating provides superior catalyst efficiency with a lower amount of precious metals used as active components of the catalyst. In terms of thermal stress levels during operation of a ceramic filter, silicon nitride is comparable to cordierite, the typical industry standard material at this point in time due to its lower thermal expansion and lower elastic modulus.

The material that is used to construct the ceramic filters heavily influences filter performance. For example, filtering performance of the particulate matter and the durability of long term operation of the ceramic filter are greatly affected by the ceramic that is used. Basic performance requirements include, but are not limited to, (1) thermal resistance to particulate matter burning; (2) mechanical strength against cyclic thermal stress; (3) chemical stability against loaded materials such as particulate matter and ash; and (4) sufficient porosity for particulate matter filtering. It has been determined that silicon nitride may be configured to provide a highly advantageous ceramic filter.

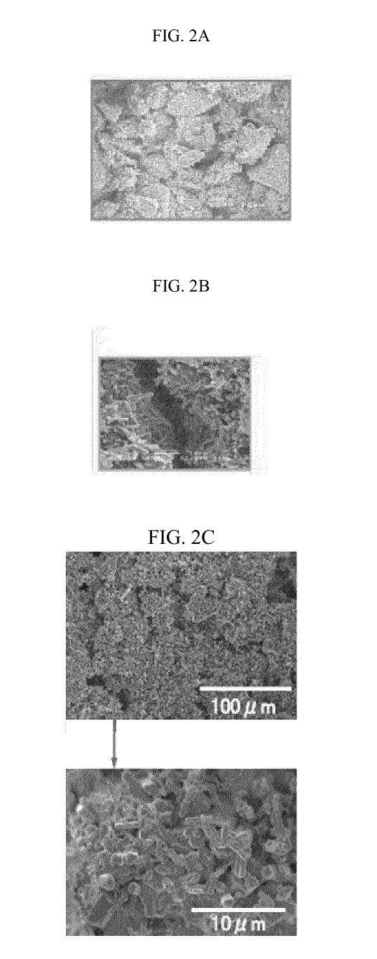

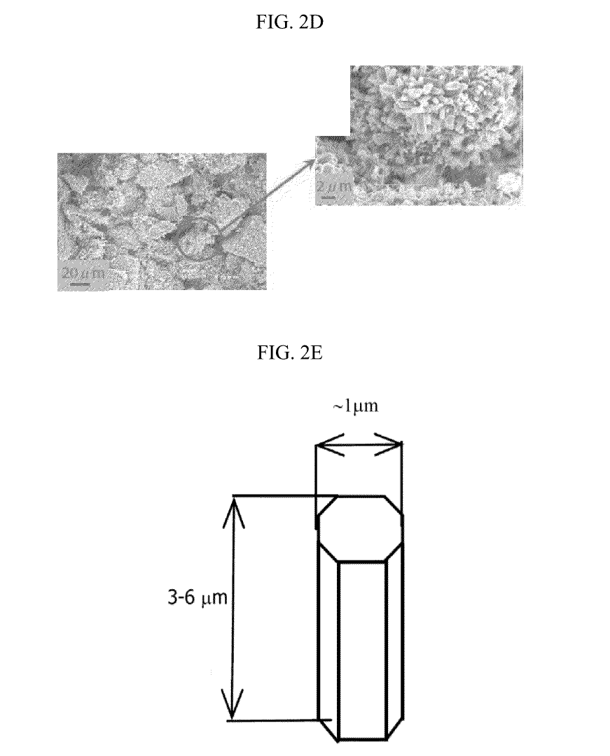

Silicon nitride can provide a columnar micro-structure that allows for the achievement of certain advantages. FIGS. 2A-2D show electron micrographs of the crystalline structure of an embodiment of the silicon nitride ceramic filter. In particular, micrographs show the micro-structure of a ceramic filter constructed from Si₃N₄. In FIG. 2A crystal blocks are observed, and FIG. 2B is a higher resolution micrograph showing the individual crystals. As seen in FIGS. 2C and 2D, the crystal blocks have individual crystals that are substantially hexagonal in shape. As illustrated in FIG. 2E, the crystals have a columnar shape (i.e. they are rod-like) and are not needle-like which would have sharp ends. For such crystals, the length to diameter ratio (L/D) is approximately 3-6. Hexagonal crystals have a stronger column-based shape structure when compared to the needle-like structure of other compounds. As may be seen in FIGS. 2B, 2C, and 2D, the crystal blocks have an elongated structure. The presence of elongated crystals also results in a higher specific surface area which leads to advantages in terms of catalyst loading, and provides a larger surface area for more of a catalyst reaction to take place. The unique hexagonal and elongated structure of the silicon nitride crystals also allows more particulate matter to be collected in the ceramic filter. In particular, smaller particulate matter and particulate matter of smaller sizes are able to be collected with crystals of such a shape. The elongated structure of the crystals also presents a variety of advantages in terms of wash-coating, as will be described below. In some embodiments, the elongated crystals are β-phase Si₃N₄.

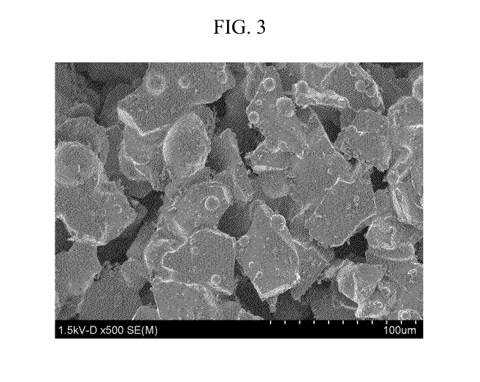

The micro-structure of silicon nitride allows it to capture more particulate matter than silicon carbide. For purposes of comparison, FIG. 3 illustrates a silicon carbide crystalline structure that is employed in ceramic filters. The micro-structure of the silicon carbide exhibits a grainy crystal structure. By comparing FIG. 3 with FIGS. 2A-2D, as well as by comparing the size scales, it may be seen that the size of a crystals of the silicon carbide are on the order of one hundred times larger than the crystals of silicon nitride. As illustrated in the micrographs, silicon nitride may have a fine columnar crystal with a crystal diameter of approximately 1 μm. See FIG. 2C. Because of the larger grain size, more particulate matter is allowed to pass through the silicon carbide compared to the smaller grain sizes of the silicon nitride. In other words, silicon nitride will collect more particulate matter due to its micro-structure.

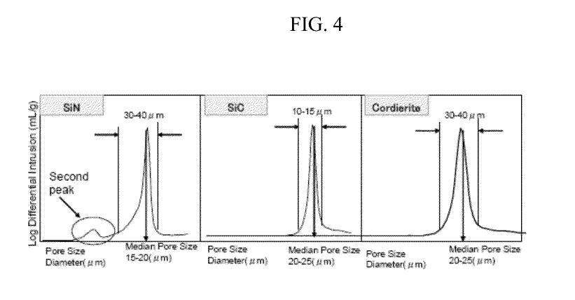

Silicon nitride also exhibits a more desirable pore distribution than either silicon carbide (SiC) or cordierite as illustrated in FIG. 4. For example, silicon nitride exhibits a median pore size of 15 to 20 μm, compared to a pore size of 20 to 25 μm for both silicon carbide and cordierite. Such smaller pore size may reduce back pressure and clogging. The smaller pores are constructed by numerous micro-crystals that exhibit advantages for catalyst loading, due to higher surface area. Furthermore, the larger pore sizes allow for the passage of particulate matter that otherwise would be desirably filtered. The median pore size of 20-25 μm for cordierite has a lower back-pressure that is larger than silicon carbide, but cordierite may have a lower particulate matter loading capacity due to its lower mechanical strength and lower thermal capacity.

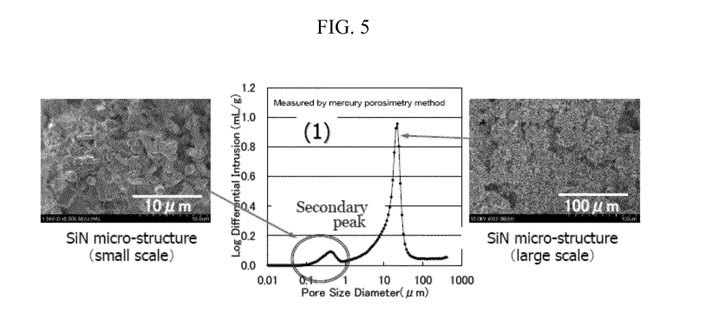

FIG. 5 illustrates a graph and accompanying electron micrographs that provide more detailed insight regarding the pore distribution that may be achieved through use of silicon nitride. The graph shows the log differential of intrusion (mL/g) as a function of pore size diameter (μm) for silicon nitride, as measured by mercury porosimetry. The first, or main, peak in the graph is related to crystals having an average pore size diameter of 15-20 μm. The second peak in the graph is related to crystals having a pore size diameter of 0.5-0.6 μm. The second peak represents micro-pores in the crystal blocks as shown above in FIG. 2. The shape of the silicon nitride at the first peak reveals that the silicon nitride may exhibit lower back pressure due to its high porosity, which may reach 60-64% porosity. Accordingly, clogging from build-up is minimized. The second peak of silicon nitride also shows smaller pores located in the crystal blocks. Such small pores have advantages for catalyst loading.

Due to the micro-structure of silicon nitride, there is not a distinct correlation between particulate matter trapping performance and back pressure increase and not a distinct relationship based on pore volume and wall thickness. The micro-structure of conventional ceramic filter materials such as silicon carbide, cordierite and silicon nitride are quite different. Therefore, pore distribution and its effect on filter operation may be unrelated concepts. For the micro-structure of silicon nitride, the pore distribution under 10 μm is more important than a large size pore distribution over 25 μm. A pore distribution of under 10 μm may cause the effect of increasing lower back-pressure during particulate matter accumulation. It appears that micro-pores under 10 μm may not be ventilated after the main pores are clogged by particulate matter accumulation. Furthermore, the second peak under 10 μm is a result of the process of the present disclosure, and indicates that the pore volume should be kept under 10 μm. In some embodiments, one feature of silicon nitride is a large amount of pores under 10 μm. This has advantages such as, for example, being able to apply large amounts of wash-coating for catalyzing and also being able to ventilate the filter in order to reduce the increasing of back pressure.

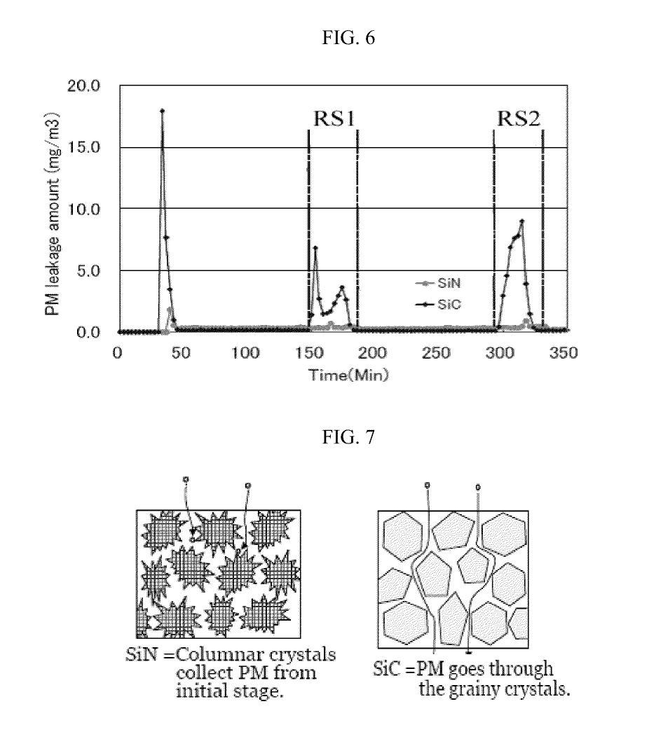

Silicon nitride may be configured to provide relatively low particulate matter leakage. FIG. 6 is graphs comparing the particulate matter leakage of silicon nitride and silicon carbide ceramic filters. The graph exhibits the particulate matter leakage amount (mg/m³) as a function of time (minutes) for both silicon carbide and silicon nitride. The initial leakage of the filter is during the time period immediately preceding 50 minutes, the particulate matter leakage for silicon carbide is significantly higher (close to 18.0 mg/m³) than that for silicon nitride (less than 1.0 mg/m³). During the first and second regeneration stages of the filter (RS1 and RS2), similar results are observed. During the first regeneration stage, the particulate matter leakage of silicon carbide is significantly higher (approximately 7.0 mg/m³) than that for silicon nitride (less than 0.5 mg/m³). During the second regeneration stage, the particulate matter leakage of silicon carbide is even higher (close to 8.0-9.0 mg/m³), while the particulate matter leakage of silicon nitride remains relatively constant (less than 0.4-0.5 mg/m³). The hexagonal, elongated structure of the silicon nitride crystals collect more particulate matter during the initial stage and regeneration stages relative to the silicon carbide crystals, which leads to much lower particulate matter leakage. This is captured in the cartoon illustration of FIG. 7.

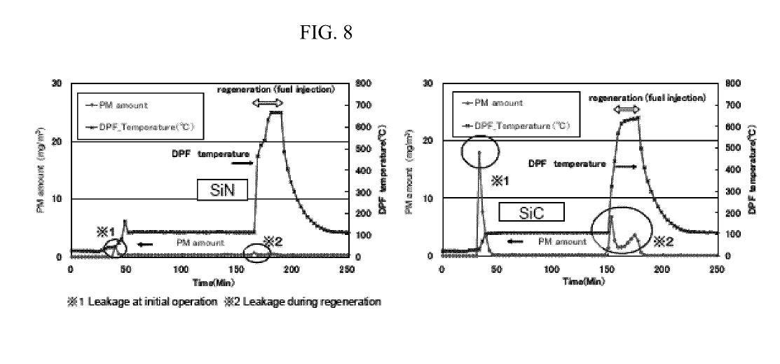

FIG. 8 includes graphs for both silicon nitride and silicon carbide illustrating the relatively low particulate matter leakage made possible by silicon nitride. In FIG. 8, the graphs are dual axis graphs having the ceramic filter temperature (top curve) as well as the particulate matter amount (bottom curve) for silicon nitride and for silicon carbide. As will be noted, the ceramic filter temperature in the figures is similar, however, the particulate matter amount curve for the silicon nitride is much lower and remains relatively stable, compared to the particulate matter amount curve for the silicon carbide. The silicon carbide exhibits high spikes at the initial stage time (around 50 minutes) and also during regeneration (150-180 minutes). Therefore, high particulate matter leakage amounts can clearly be seen for silicon carbide during the initial stage and during regeneration, whereas the particulate matter leakage amounts are consistently low for silicon nitride. The engine used to obtain the information for FIG. 8 was an in-line 4 cylinder engine having a 2.2 L displacement, a maximum output of 36.4/2800 kW/min, and a maximum torque of 150/1680 Nm/min. The filters were 5.66×6 inch (2.5 L) filters coated with a wash-coating of 20 g/l and Pt at 0.5 g/L.

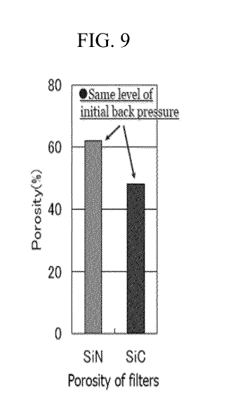

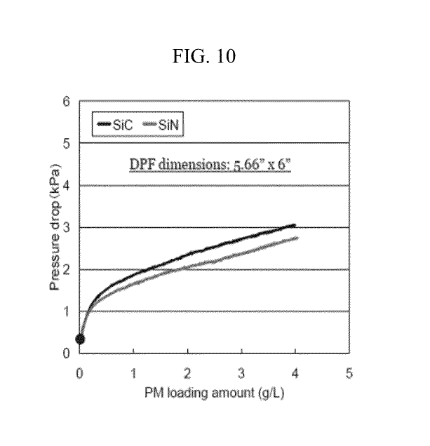

Silicon nitride provides a slower increase in back pressure than compared to silicon carbide. FIG. 9 is a graph illustrating the porosity of typical silicon nitride and silicon carbide filters. As may be seen, the porosity of silicon nitride (roughly 60%) is higher than the porosity of silicon carbide (42-43%). FIG. 10 is a graph illustrating the particulate matter loading amount for the two materials. The shows the backpressure increase during particulate matter loading. The silicon nitride curve (lower) exhibits less of a pressure drop (in kPa) as compared to the silicon carbide curve (higher) as a function of the particulate matter loading amount (g/L). It is believed that the micro-structure of silicon nitride causes a slower increase in back pressure.

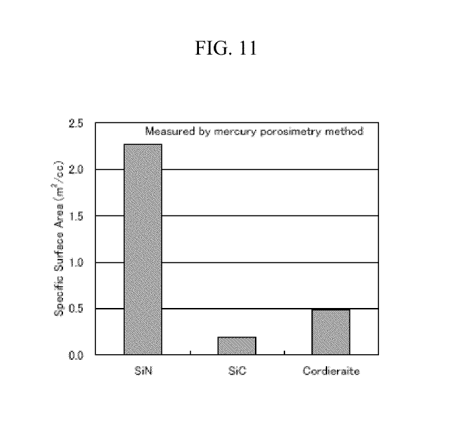

Silicon nitride, also provides a ceramic filter with improved catalyst loading properties. FIG. 11 is a graph illustrating the specific surface areas of grains of silicon nitride, silicon carbide, and cordierite. FIG. 11 illustrates that silicon nitride has a much higher specific surface area (m²/cc) when compared to silicon carbide and cordierite, which leads to much higher catalyst loading capabilities. The specific surface area of silicon nitride is over 10 times higher than that of silicon carbide. The higher specific surface area leads to more of a surface area for catalytic reactions, therefore the catalyzing performance may be improved by using silicon nitride, particularly for a rare-metal. The high specific surface area combined with the smaller pores of silicon nitride also lead to improved catalytic properties. In some embodiments, the specific surface areas of the elongated crystals are relevant in post-sintering, because the columnar crystals are in the process of elongating.

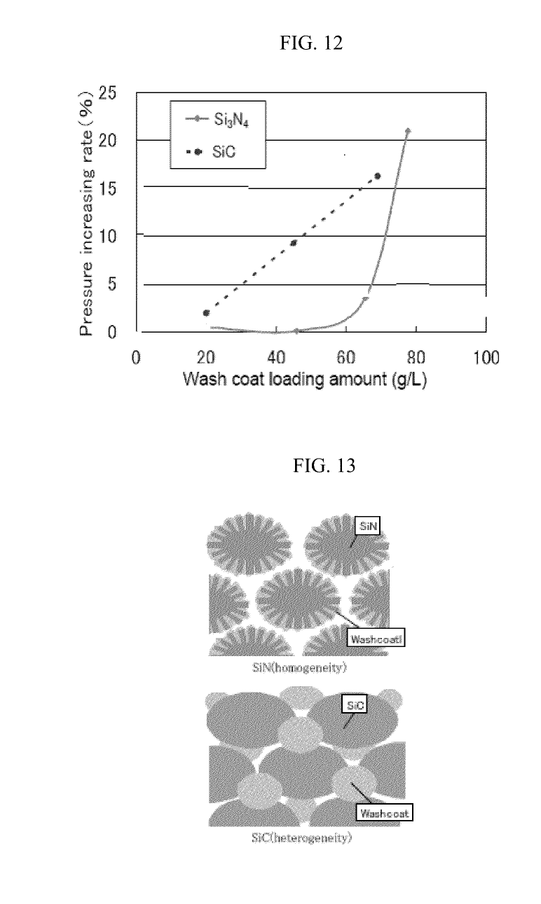

The use of silicon nitride is particularly advantageous with regarding to wash-coating. FIG. 12 is a graph illustrating the pressure increasing rate (%) as a function of wash-coat loading amount (g/L) for both silicon carbide (dotted line) and silicon nitride (solid line). Silicon nitride enables a high amount of wash-coating with a lower back pressure by thin coating. The reason for this lower back pressure increase in silicon nitride is attributed to silicon nitride's crystal distribution, whereby the wash-coating fills in the space between crystals, where in silicon carbide, the wash-coating must fill in the smoother surface, thereby obstructing pathways through the material. See FIG. 13. As may be seen from FIG. 13, it is believed that the surface area of silicon nitride is smoother after wash-coating as compared to the silicon carbide. Therefore, there is more homogeneity with silicon nitride versus the heterogeneity with silicon carbide.

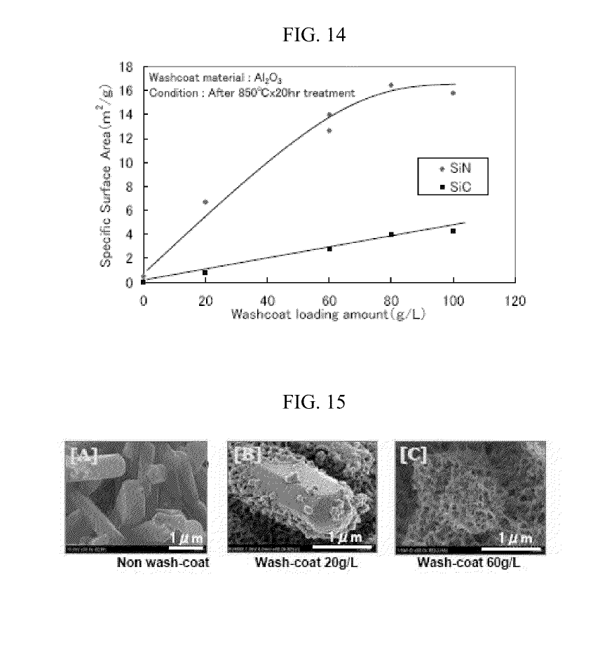

As illustrated by the graphs in FIG. 14, the pore distribution after a high amount of wash-coating exhibited a large variation in the region under 10 μm. The function over 10 μm pores kept the gas permeability of silicon nitride by accumulating a high amount of wash-coating under the 10 μm region. Additionally, a higher amount of alumina wash-coat on silicon nitride resulted in a higher specific surface area as measured by mercury porosimetry, thereby resulting in improved catalytic properties.

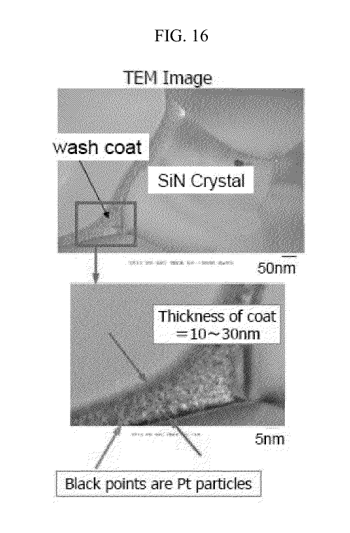

FIGS. 15A, B, and C are electron micrographs of silicon nitride after wash-coating. The micro-structure shows that a homogeneous wash-coating of aluminum oxide occurs on the elongated hexagonal crystals of silicon nitride. The micro-structure shows silicon nitride without the wash-coat (FIG. 15A), with an aluminum oxide wash-coat at 20 g/L (FIG. 15B), and an aluminum wash-coat at 60 g/L (FIG. 15C). FIG. 16 illustrates tunneling electron microscopy (TEM) images of the wash-coat having a thickness of 10 to 30 nm. The black points in the TEM images are particles of platinum. The higher amount of wash-coating has a number of additional advantages. For example, a higher catalyst activity would occur by reducing the sintering of active components (or precious metals) of the catalyst.

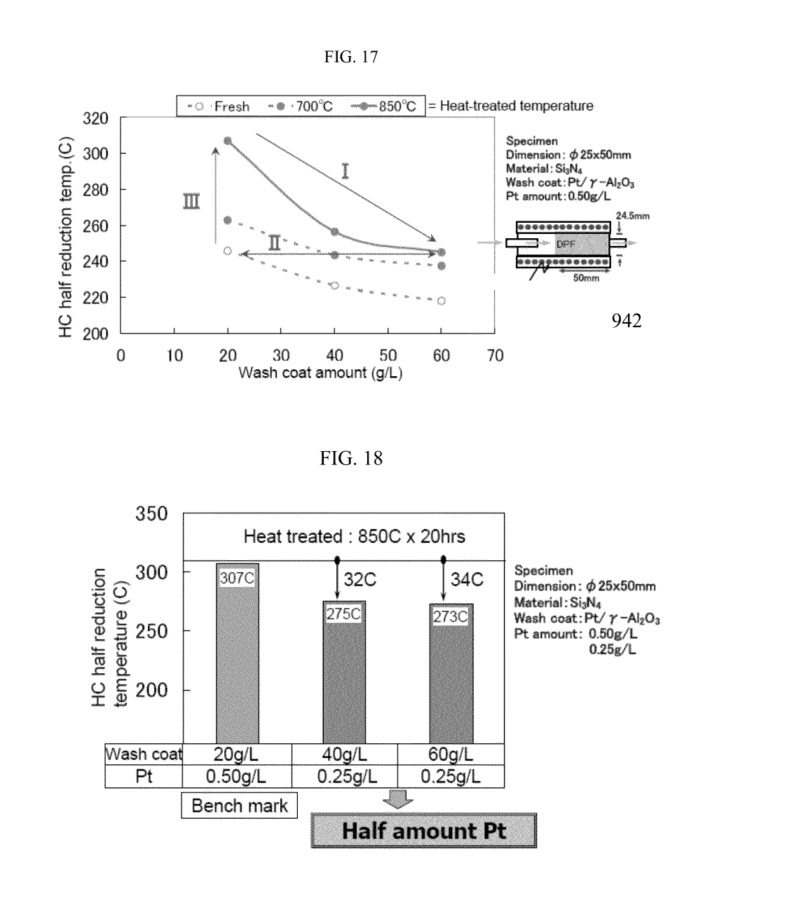

FIG. 17 is a graph illustrating the relationship between hydrocarbon (HC) half-reduction temperature and the wash-coat amount of silicon nitride. The graph is a plot of the HC half reduction temperature (T50) as a function of the wash-coat amount (g/L). A lower HC half-reduction temperature is desirable as it indicates that the catalyst has good activity. The HC half-reduction temperature is the temperature at which the amount of HC is reduced to half an original value. The test specimen is illustrated to the right of the graph. In phase I, the HC half reduction temperature goes down with the wash-coat amount. In phase II, the 850° C. heat-treated 60 g/L and the “Fresh” curve at 20 g/L are at the same level. In phase III, the wash-coat at 20 g/L is deteriorated by sintering during heat-treatment to a lower activity.

FIG. 18 is a graph illustrating how a larger amount of wash-coat retains a higher catalyst dispersion. This is effective for conserving platinum, the active component in the catalyst. For each of the different wash-coat values (20 g/L, 40 g/L, and 60 g/L), the HC half reduction temperature is provided. The wash-coat of 20 g/L is deteriorated by the treatment, but higher wash-coat values (40 g/L and 60 g/L) keep a higher catalyst dispersion, and as a result, more platinum is conserved.

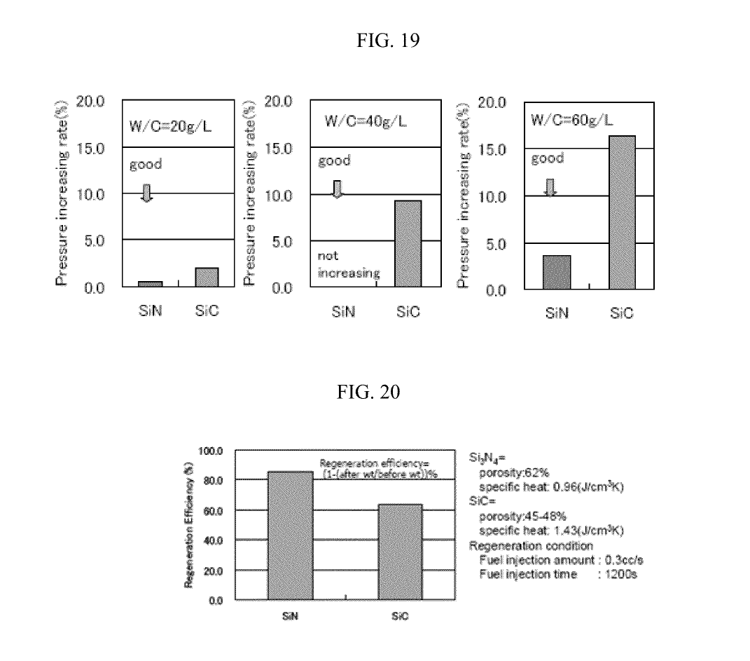

FIG. 19 is a series of 3 graphs illustrating the pressure increases for different wash-coating values (20 g/L, 40 g/L, and 60 g/L) for both silicon nitride and silicon carbide. For the 40 g/L, the back-pressure did not increase at all for silicon nitride up to 40 g/L of the wash-coat amount, and exhibited an increase of only 3.6% against non-wash-coating at 60 g/L of a wash-coat amount in 60 g/L. The increase was also low for the wash-coating of 20 g/L in the 20 g/L. The reason for this lower back pressure increase in silicon nitride may be attributed to its pore distribution. The pore distribution after a high amount of wash-coating exhibited a larger variation under the 10 μm region. The function over 10 μm pores kept the gas permeability of the silicon nitride by accumulating a high amount of wash-coating under the 10 μm region.

FIG. 20 is a graph of the regeneration efficiency (%) for silicon nitride and silicon carbide. A silicon nitride ceramic filter substrate has a lower thermal capacity due to its higher porosity and lower specific heat. Lower thermal capacity normally results in higher regeneration efficiency. As shown in the graph, both regeneration conditions were the same, with fuel injection for 1200 seconds, and the porosity and specific heat values for both silicon nitride (Si₃N₄) and silicon carbide can also be seen. However, the regeneration efficiency for silicon nitride is significantly higher than for silicon carbide.

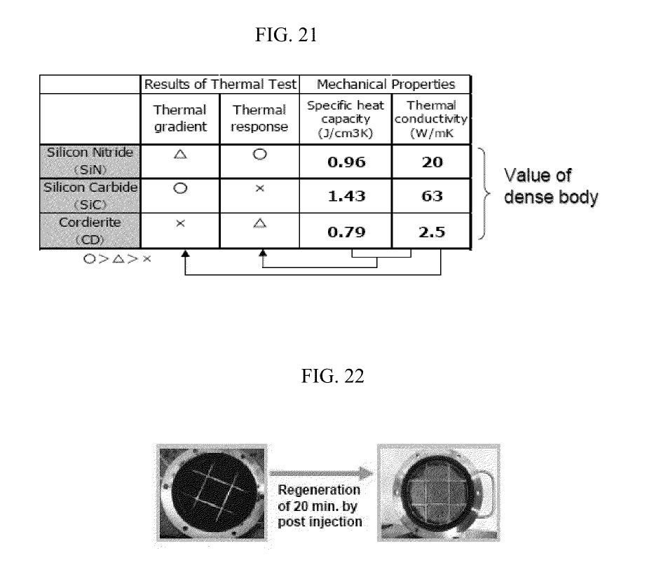

FIG. 21 includes a table compiling thermal gradient, thermal response and mechanical properties of the silicon nitride, silicon carbide, and cordierite. Properties tested include specific heat capacity (J/cm³K) and thermal conductivity (W/mK). The values for silicon nitride overall point to a higher and more efficient regeneration as compared to the comparative compounds. FIG. 22 shows an actual illustration of what the ceramic filter looks like after regeneration of 20 minutes by post injection. Based upon the photo in FIG. 22, it is clear that silicon nitride provides superior regeneration efficiency compared to silicon carbide and cordierite.

Due to the use of silicon nitride in ceramic filter fabrication, it is not necessary to be concerned with issues such as seal layer thickness and thermal conductivity to achieve a high level of combustion performance in regeneration. Silicon nitride has a lower thermal volume material than, for example, silicon carbide. Accordingly, silicon nitride has very good combustion performance in regeneration. The micro-structure of silicon nitride enables higher porosity with same level of strength. Silicon nitride has lower specific heat and higher porosity, and that combination enables lower thermal volume. Lower thermal volume can provide good burning performance, and leaves little unburned material.

Table 1, below, provides various properties of silicon nitride, silicon carbide, and Cordierite used to make ceramic filters. The table shows the values of thermal expansion, Young's Modulus, the Temperature Gradient and the Thermal Stress per Unit.

TABLE 1
Properties of Ceramic Filter Materials.

| | Thermal | Young's | Temperature | Thermal Stress |
|---|---|---|---|---|
| | Expansion | Modulus | Gradient | per Unit |
| Material | (×10⁻⁶/° C.)^{a} | (GPa)^{b} | (° C./mm)^{c} | (MPa/mm)^{d} |
| Silicon Nitride | 2.94 | 3.1 | 9.9 | 0.09 |
| Silicon Carbide | 4.75 | 6.6 | 8.8 | 0.28 |
| Cordierite | 0.81 | 2.9 | 23.4 | 0.06 |

^{a}Thermal expansion was calculated honeycomb specimen (2 cell × 2 cell × 20 mm).
^{b}Young's modulus was measured by honeycomb specimen (3 cell × 2 cell × 40 mm)
^{c}Temperature gradient was measured in regeneration test with honeycomb specimen (35 × 35 × 150 mm)
^{d}Thermal stress per unit was calculated as [thermal stress] × [Young's modulus] × [temperature gradient]

Table 2 lists the porosity (%), compressive strength (MPa), thermal expansion coefficient, Young's modulus, and thermal conductivity for silicon nitride (Si₃N₄), silicon carbide and cordierite.

TABLE 2
Additional Properties of Ceramic Filter Materials.

| Material | Si₃N₄ | Silicon Carbide | Cordierite |
|---|---|---|---|
| Porosity (%) | 60-64 | 45 | 60 |
| Compressive | 6-10 | 6 | 1 |
| Strength (MPa) | | | |
| Thermal | 2.9 | 4 | 1 |
| Expansion | | | |
| (×10⁻⁶/° C.) | | | |
| Young's | 3.1 | 6 | 3 |
| Modulus (GPa) | | | |
| Thermal | 20-40 | 60 | 2 |
| Conductivity | | | |
| (W/mK) | | | |

As is shown, silicon nitride yield a low thermal stress, good thermal conductivity and high strength or thermal stress. As a result, silicon nitride has a high limitation on particulate matter accumulation, low particulate matter leakage, strong thermal strength, low back pressure, and may be conveniently and efficiently be implemented in monolithic structure.

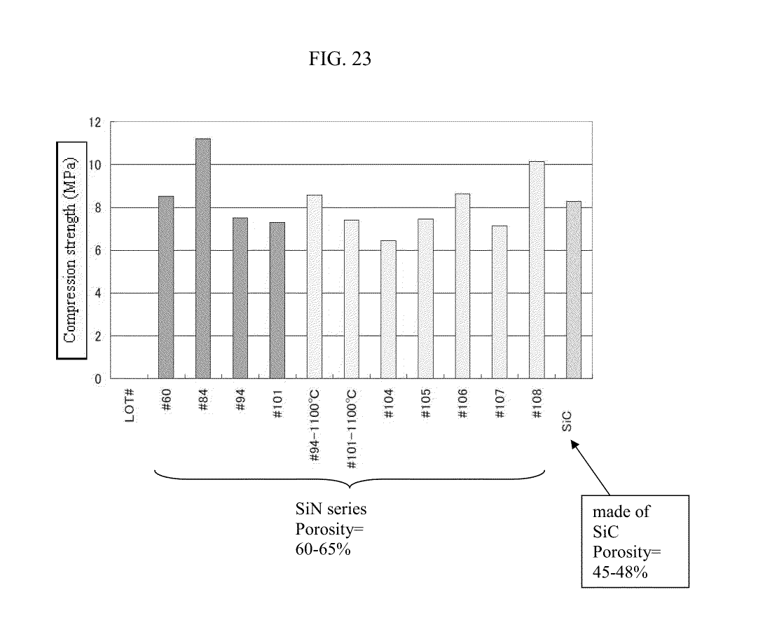

Silicon nitride may be configured to provide improved strength. FIG. 23 includes a graph illustrating strength of silicon nitride. The graph shows the compression strength (in MPa) of various compounds that have either silicon carbide or silicon nitride. Lot #s 60, 84, 94, 101, 94-1100° C., 101-1100° C., 104, 105, 106, 107, 108 include silicon nitride, which may have a porosity ranging from 60 to 65%. The right-most silicon carbide lot is made of silicon carbide with a porosity ranging from 45 to 48%. As may be seen, the materials that have silicon nitride have a stronger compression strength. Strength tends to have an inversely proportional relationship with permeability, and achieving the same level of strength with silicon nitride or silicon carbide with a lower back pressure is a goal. Moreover, it is not necessary, when using silicon nitride, to rely on flatness of joining planes to obtain sufficient bonding strength. The silicon nitride micro-structure has the effect of maintaining the bonding strength including the durability, without regard to the flatness of the segments. The outer surface of silicon nitride segments also have elongated columnar crystals, which sometimes may get twisted up with seal materials. So, regardless of the flatness of the segments, the bonded segments provide sufficient strength for stable operation.

Silicon nitride also may be used to achieve better characteristics related to ash accumulation. Table 3 shows the particulate matter ratio (or particulate matter collecting efficiency) and the ash accumulation. As may be seen from the table, the ash accumulation properties for silicon nitride are better than silicon carbide, even though the particulate matter collecting efficiency may be at similar levels.

TABLE 3
Ash Accumulation

| | Silicon Nitride | Silicon Carbide |
|---|---|---|
| Material | Good^{a} | Good^{a} |

| | | | |
|---|---|---|---|
| PM Ratio | Before Test | 98.3% | 98.9% |
| | After Test | 97.5% | 97.4% |

| | | |
|---|---|---|
| Ash Accumulation | 24.6 g | 27.8 g |

^{a}“Good” refers to no physical damage upon visual inspection.

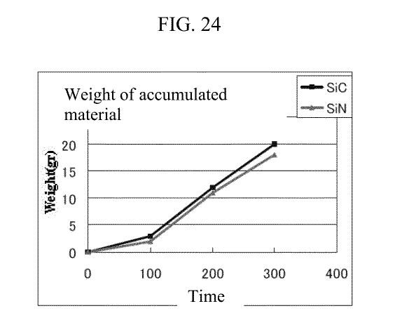

FIG. 24 graphically represents the advantage of silicon nitride with regard to ash accumulation. FIG. 24 is a graph illustrating the weight (in grams) of accumulated material of both silicon carbide and silicon nitride as a function of time (in hours), according to the testing from Table 3. FIG. 24 shows a measurements conducted during the testing and involving both the filter and the metal can (unlike the data in Table 3, which is only for the filter). Silicon carbide has a greater accumulation of material or ash accumulation as compared to silicon nitride. Reducing the accumulation of ash or material is better for efficient engine flow as well as general cleanliness of an engine system.

Silicon nitride has unique properties to provide good properties related to ash accumulation. Silicon nitride has excellent corrosion resistance against ash components such as CaSO₄ and CaCO₃. If the silicon nitride includes magnesium (Mg) as part of the composition from the sintering additives, it should have additional effect to increase the corrosion resistance against ash. Magnesium may be provided by using MgAl₂O₄ as one of sintering additives. Silicon nitride has a lot of micro-pores under 10 μm, so that the contacting section(area) is lower than large grain size materials such as silicon carbide. Both the corrosion resistance of silicon nitride and large amount of micro-pores in the micro-structure of silicon nitride have the effect of reducing ash accumulation. The present configuration does not require any specific relationship between the length and width of cells and the surface roughness of the cell walls to achieve the desired ash accumulation characteristics, as may be required with other materials.

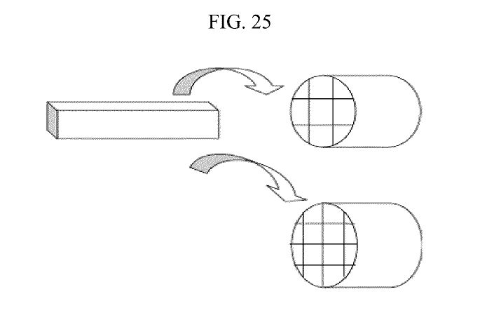

FIG. 25 shows an example segmented composite ceramic filter body, in accordance with one aspect. The composite ceramic filter body is formed from a plurality of segments. The ceramic filter has a generally circular cross section. The ceramic filter may be manufactured by bonding together a plurality of the filter segments, to form a rectangular shape, an approximately hexagonal shape, or an approximately octagonal shape. These may then be machined into a circular, hexagonal, or octagonal shape as the final form of the ceramic filter.

As noted above, also provided is a process for manufacturing a ceramic filter. The process also include preparation of a silicon nitride ceramic filed via a post-reaction sintering process. The process includes mixing silicon, yttrium oxide-doped zirconia, Mg—Al spinel (Mg Al₂O₄), silicon nitride, a pore-forming material, and a binder to form a ceramic precursor, extruding the ceramic precursor into a generally honeycomb shaped monolithic filter precursor or into a single filter tube precursor, drying the filter precursor or filter tube precursor to form a dried ceramic precursor, heating the dried ceramic precursor to remove the binder (i.e. “debindering”), sintering to form the silicon nitride ceramic filter (i.e. “post-reaction sintering”). The silicon nitride that is mixed in the process acts as a core of the crystal block after sintering.

According to various embodiments, the pore-forming material may be any kind of organic particle. According to various embodiments, the drying may be conducted in a microwave dryer. According to various embodiments, the debindering may be conducted at a temperature of from about 200 to about 500° C. The silicon nitride ceramic filter contains (β-Si₃N₄, ZrO₂(Y₂O₃), MgO, and Al₂O₃.

According to various embodiments, the sintering includes two steps at different temperatures. A first step of nitriding of the silicon is conducted at a temperature of about 1300° C. to about 1500° C. in the presence of nitrogen. The initial nitriding produces an α-Si₃N₄. A second step of porosity control is then conducted at a temperature of about 1600° C. to about 1800° C., and at this temperature the α-Si₃N₄ is converted to β-Si₃N₄. The sintering provides a dense body of silicon nitride and the other materials, and provides the silicon nitride in the elongated columnar crystals described above.

In the ceramic precursor, the silicon is present from about 20 wt % to about 25 wt %, the yttrium oxide-doped zirconia is present from about 0.4 wt % to about 3 wt %, the β-Si₃N₄ is present from about 15 wt % to about 25 wt %, the pore-forming material is present from about 10 wt % to about 20 wt %, and the organic binder, as well as water, if present, is present from about 35 wt % to about 45 wt %. The final silicon nitride product contains the β-Si₃N₄ at greater than or equal to about 93 wt %, yttrium oxide-doped zirconia at less than about 1.5 wt %, and MgO and Al₂O₃ at less than about 5.5 wt %.

The process may also include a cell-plugging step, where any given cell is plugged or obstructed at one end. The cell-plugging thus results in a checkerboard like pattern on the proximal or distal faces of the segment or the monolithic form. The materials may then again be dried and subjected to a heat treatment. Where the ceramic is a segment for forming a composite ceramic filter, the segments are then bonded together in a bonding step by providing a layer of adhesive between the segments and then heating them together to bond them. In some embodiments, the adhesive includes cordierite and aluminum oxide. Additional heat treatment and machining may then be conducted on the ceramic body. This process may be further explained by reference to the figures, and the following description.

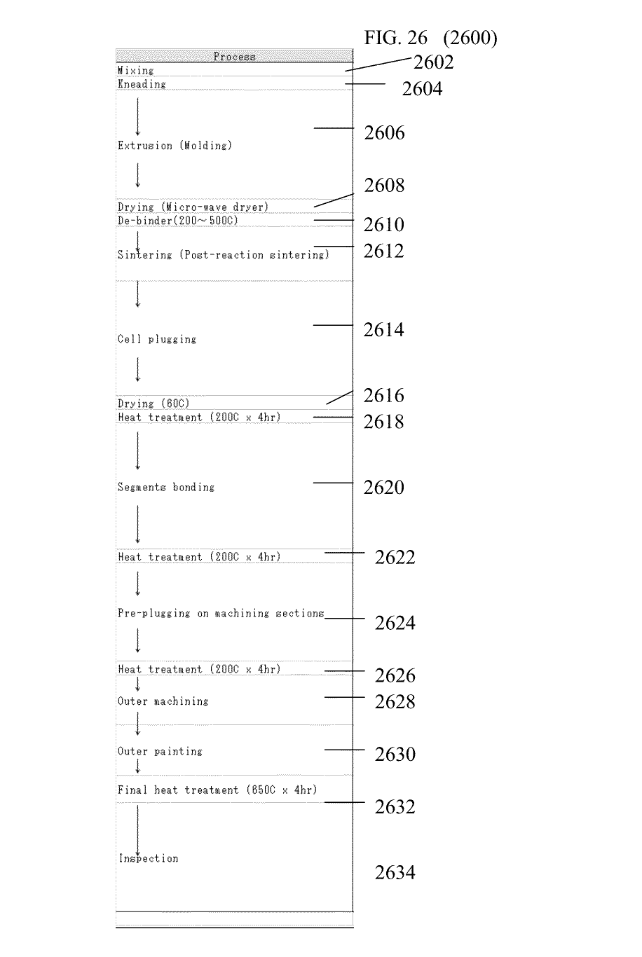

FIG. 26 is a flow diagram generally outlining a process to manufacture the segmented ceramic filter, in accordance with an aspect of the present disclosure. Initially, the materials for the ceramic filter are mixed and kneaded in a mixing step 2602 and a kneading step 2604. The materials can include metal Si, Si₃N₄, and additives. An example of the materials that may be used to form a silicon nitride ceramic filter are shown in Table 4.

TABLE 4
Materials for forming silicon nitride filters.

| | Material | Particle Size | Wt % |
|---|---|---|---|
| Primary Materials | Si (silicon) | 50-80 μm | 20-25 |
| | Zirconia (zirconium | 0.1-1.5 μm | 0.1-3 |
| | oxide) | | |
| | ZrO₂(Y₂O₃) (8 mol %) | | |
| | Mg—Al spinel | 0.1-2 μm | 1-6 |
| | (MgAl₂O₄) | | |
| | β-Si₃N₄ | 30-60 μm | 15-25 |
| Secondary Materials | Pore Making Material | 15-150 μm | 10-20 |
| Binder | Organic binder | | 35-45 |
| | | Total | 100 |
| | Final Products | β-Si₃N₄ | >93 |
| | | ZrO₂(Y₂O₃) | <1.5 |
| | | MgO and Al₂O₃ | <5.5 |

The mixed materials are then extruded in step 2606 into segments with a generally honeycomb shape. The extruded segment may be, for example, a rectangular or prism-like shape. The segment preferably has round, chamfered corners. In some embodiments, the segmented corner has a radius of greater than 2.6 mm. In conditions of 260 cpsi, the radius of the segmented corner R is over 2.6 mm, and the three cells at the corner may have deformation and be reduced in cell area. Silicon nitride has, however, lower back pressure during operation and such a reduction of cell area has no deleterious effects. Actually, a larger radius of greater than 2.6 mm has a good effect in increasing the mechanical strength of bonded segments.

After extrusion, the segment is subjected to a drying step 2608 (using a micro-wave dryer) and a de-bindering step 2610 (e.g., at 200-500° C.).

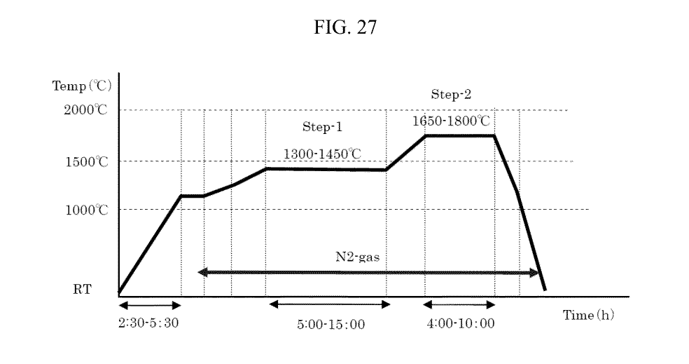

The segment is subsequently subjected to a sintering step 2612 (or post-reaction sintering). A unique sintering process known as “post reaction sintering” has been adopted. It can include two steps of temperature zones for: (1) nitriding metal silicon (1300-1450° C.) and (2) porosity controlling (1650-1800° C.). The post reaction sintering may be utilized to develop a dense body, and may also be modified to develop a porous body in order to generate elongated columnar crystals. FIG. 27 is a chart illustrating the conditions of the post-sintering process. For example, at step 1, the compound is heated at 1300-1450° C. for 5-15 hours and at step 2, the compound is heated at 1650-1800° C. for 4-10 hours. A gradual temperature increase occurs for the first 2.5 hours to 5.5 hours, then a constant temperature close to 1100° C. is maintained for 10 minutes, and then a change of rate in temperature less than 50° C. per hour occurs for 1 hour and 40 minutes to reach the level of Step 1 at 1300-1450° C.

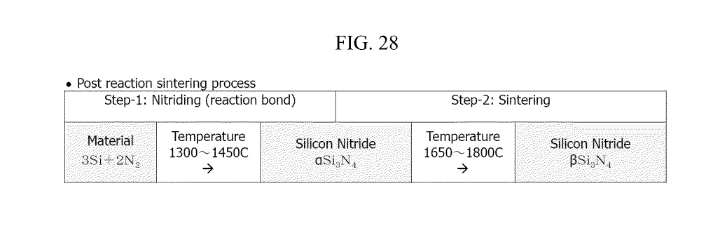

FIG. 28 includes a table that describes addition details regarding step 1 (nitriding) and step 2 (sintering) of the post-reaction sintering process. For instance, a material such as 3Si+2N₂ is combined and heated at 1300-1450° C. in step 1 to eventually become silicon nitride, or α-Si₃N₄. Then in step 2, sintering occurs where the α-Si₃N₄ is heated at 1650-1800° C. at which temperature it converts to β-Si₃N₄.

Following the sintering step 2612, a cell-plugging step 2614 is conducted in a conventional fashion. Typically, each cell will be plugged on only one end. The cell-plugging results in a checkerboard like pattern on the end of the segment. Next, a drying step 2616 (e.g., at 60° C.), and then a heat treatment step 2618 (e.g., at 200° C. at 4 hours) are conducted.

The segments are then bonded together in a bonding step 2620. Typically a sealing layer of adhesive is disposed between the segments to bond them together.

A further heat treatment step 2622 (e.g., 200° C. at 4 hours) is then conducted, followed by a pre-plugging step 2624 on the machined sections. Certain cells may be pre-plugged with, for example, a sealing layer material. The cells that will form the outer surface of the assembly after outer machining, are filled with the sealing layer material. As a result, when the outer machining is complete, the outer surface will be essentially uniform and leakage will be decreased.

A further heat treatment step 2626 (e.g., at 200° C. at 4 hours) is then conducted, followed by an outer machining step 2628. The outer machining may be performed, for example, by a turning lathe. Thereafter, the outer surface is painted in a painting step 2630 and the assembly is subjected to a final heat treatment step 2632 (e.g., at 650° C. at 4 hours). An optional inspection step 2634 may be conducted.

### EQUIVALENTS

While certain embodiments have been illustrated and described, it should be understood that changes and modifications may be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process for manufacturing a ceramic filter comprises:
mixing silicon, yttrium oxide-doped zirconia, magnesium-aluminum spinel, silicon nitride, a pore-forming material, and a binder to form a ceramic precursor;
extruding the ceramic precursor into a generally honeycomb shaped monolithic filter precursor or into a single filter tube precursor;
drying the filter precursor or filter tube precursor to form a dried ceramic precursor;
heating the dried ceramic precursor to remove the binder; and
sintering to form the silicon nitride ceramic filter.

2. The process of claim 1, wherein the heating the dried ceramic precursor to remove the binder is conducted at a temperature of from about 200° C. to about 500° C.

3. The process of claim 1, wherein the silicon nitride ceramic filter comprises β-Si₃N₄, ZrO₂(Y₂O₃), MgO, and Al₂O₃.

4. The process of claim 1, wherein the sintering comprises nitriding the silicon at a temperature of about 1300° C. to about 1500° C. in the presence of nitrogen, followed by heating at a temperature of about 1600° C. to about 1800° C.

5. The process of claim 1, wherein the ceramic precursor comprises silicon from about 20 wt % to about 25 wt %, yttrium oxide-doped zirconia from about 0.1 wt % to about 3 wt %, magnesium-aluminum spinel from about 1 wt % to about 6 wt %, β-Si₃N₄ from about 15 wt % to about 25 wt %, pore-forming material from about 10 wt % to about 20 wt %, and organic binder from about 35 wt % to about 45 wt %.

6. The process of claim 1, wherein the silicon nitride ceramic filter comprises β-Si₃N₄ at greater than or equal to about 93 wt %, yttrium oxide-doped zirconia at less than about 1.5 wt %, and MgO and Al₂O₃ at less than about 5.5 wt %.

7. The process of claim 1 further comprising wash-coating the silicon nitride ceramic filter body with a wash-coating comprising aluminum oxide or titanium oxide.

8. The process of claim 7, wherein the wash-coating provides a coating of 20 g/L wash-coating or greater.

9. The process of claim 7, wherein the wash-coating provides a coating of 40 g/L wash-coating or greater.

10. The process of claim 7, wherein the wash-coating provides a coating of 60 g/L wash-coating or greater.

11. A ceramic filter comprising a monolithic or composite body comprising β-Si₃N₄ and about 20 g/L or more of a catalyst support coating on the surface of the β-Si₃N₄.

12. A porous ceramic body comprising a plurality of pores, wherein at least 10% of the plurality of pores have an average diameter of 10 μm or less.

13. The porous ceramic body of claim 12 which is constructed from silicon nitride.

14. The porous ceramic body of claim 13, wherein the silicon nitride is β-Si₃N₄.
